(19) United States
(12) Patent Application Publication
(10) Pub. No.: US 2002/0138564 A1
(43) Pub. Date: Sep. 26, 2002

(54) Universal printing and document imaging system and method

(76) Inventors: Jay A. Treptow, (US); Gregory H. Wong, (US); Gordon Hanson, (US); Kevin Hanson, (US); Kris Henderson, (US); Mike Loholt, (US)

Correspondence Address: R. Alan Burnett, BLAKELY, SOKOLOFF, TAYLOR & ZAFMAN LLP, 12400 Wilshire Boulevard, Seventh Floor, Los Angeles, CA, 90025-1026, US

(21) Appl. No.: 10/098,832

(22) Filed: Mar. 13, 2002

Related U.S. Application Data
(60) Provisional application No. 60/277,831, filed on Mar. 21, 2001.

(51) Int. Cl. G06F 15/16

(52) U.S. Cl. 709/203

(57) ABSTRACT

A system and method that enables users operating originating devices, such as PC's, laptop computers, PDA's, pocket PC's, cell phones, etc., to print documents, images, and Web pages via a “driverless” print server (DPS) system without requiring any printing device drivers to be loaded on the originating device. The server system utilizes a table driven mechanism to process and handle various printer events generated by various software applications pertaining to the documents desired to be printed by operators of the originating devices. Print data corresponding to a document is then directed over various networks to a selected target printer. The system provides two-way communication between the DPS server computer and the originating device as well as two-way communication between the DPS server computer and the target printers.

### RELATED APPLICATIONS

The present application is based on a co-pending provisional application entitled “METHOD AND APPARATUS FOR PRINTING OVER NETWORK USING A SERVER,” Ser. No. 60/277,831, filed on Mar. 21, 2001, the benefit of the filing date of which is claimed under 35 U.S.C. §119(e).

### BACKGROUND OF THE INVENTION

1. Field of the Invention

The present invention concerns computer printing in general, and in particular concerns a system and method that enables various originating devices to print to selected printers over various networks without requiring the originating devices to load any printer device drivers.

2. Background Information

Typically, in order to print out a document, it is necessary for an originating device, such as a personal computer (PC), laptop computer, personal digital assistant (PDA), pocket PC, etc., to have a printer device driver loaded prior to being able to print. The printer device driver provides an abstracted interface between the operating system (OS) and a specific printer to enable the operating system (and applications running on the OS) to communicate with any printer supported by the OS using a common set of text, graphic, and layout commands. This enables developers to develop applications without having to be concerned (generally) with the specific operations of the various printers that may be used with the application. These specific operations are handled by the OS in combination with the printer device drivers.

In today's mobile business environments, business people often encounter situations in which they are away from their home office, yet need to be able to print out documents at either a nearby printer or a selected printer proximate to a business contact they wish to provide one or more documents to. Generally, in order to print to either printer, two things need to happen. First, a mobile computing device on which the document files are stored (or through which they may be accessed) must be linked in communication with the destination printer. This may typically be performed by connecting to a network to by which the printer may be accessed, or by directly connecting to the printer via a printer cable (e.g., serial, parallel, or USB cable). In many cases, both of these connection solutions may be impractical or unavailable. For instance, many business printers are designed to be connected to a network and administrators do not want their network connection disrupted by connecting the printer to the originating mobile computing device via a printer cable. Furthermore, the network to which the printer is connected may be a private network that the administrator will not allow “foreign” computers to be connected to.

The second half of the foregoing problem pertains to the printer device driver. As discussed above, in order for the mobile computing device to be able to print via a printer, an appropriate printer device driver must be loaded on mobile computing device. In general, a specific device driver will be required for each unique type of printer (even unique models within a similar line of printers). These drivers take time to load, occupy stored space, and may cause software conflicts with other applications on the mobile computing device. Additionally, the business person may not have access to the needed driver. In some instances, a suitable printer driver may be available via the media from which the OS was originally installed, which people generally don't carry with them when away from the office. Oftentimes, the printer will comprise a model that was made available after the OS was released, whereby the only way to load the appropriate driver is to have a specific device driver that was provided with the printer. Short of being able to download the specific driver via the Internet, the business person will simply be out of luck, having no way to print via the destination printer.

### SUMMARY OF THE INVENTION

The present invention provides a system and method for allowing communications between various originating devices operating various operating systems across various networks to enable the originating devices to print documents via a “driverless” print server system without requiring any printing device drivers to be loaded on the originating device. The server system utilizes a table driven mechanism to process and handle various printer events generated by various software applications pertaining to the documents desired to be printed by operators of the originating devices. Output is then directed over various networks to a selected target printer. The server system provides two-way communication between the server and the originating device as well as two-way communication between the server and the target printers.

In a typical implementation, a user operating an originating device, such as a PC, laptop, PDA, pocket PC, cell phone, etc., accesses the Driverless Print Server (DPS) system via a Web browser, such as Internet Explorer, Netscape Navigator for devices operating Microsoft Windows operating systems, or a Web browser specific to the OS used by the originating device. By entering an appropriate URL (uniform resource locator), the user may connect to a web site that supports one or more DPS printers. The user may then select a document or image stored on the originating device or accessible through the originating device (e.g., via a network connection to a storage device on which the document is stored), select a target printer, and request the document be printed via the target printer. Optionally, the user may select a Web URL to print. The print request may further include printing options, such as number of copies, type of paper, n-up colors per page, color or monochrome, etc.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of exemplary infrastructure in accordance with one embodiment of the invention that enables users of various originating devices to print documents on selected target printers via a “driverless” print server (DPS) system, wherein printer device drivers corresponding to the target printers do not need to be loaded on the originating devices;

FIG. 2 is a block schematic diagram illustrating various software components that are used to provide the operations provided by the DPS system in accordance with one embodiment of the invention;

FIG. 3 is a representation of a Web page that is rendered via a browser on an originating device to enable a user to select to print a file;

FIG. 4 is a representation of a Web page that is rendered via a browser on an originating device to enable a user to select to print a Web page;

FIG. 5 is a representation of a Web page that is rendered via a browser on an originating device to enable a user to view status information pertaining to a previously submitted print request via the DPS system;

FIG. 6 is a representation of a Web page that is rendered via a browser on an originating device to enable a user to view the various file types that are supported by a given DPS site;

FIG. 7 is a block schematic diagram illustrating various CGI scripts that are used by the DPS system to enable interaction with consumer and administrator users;

FIG. 8 is a block schematic diagram illustrating various software components corresponding to the driverless print server software in accordance with one embodiment of the invention;

FIG. 9 is a representation of a Web page that is rendered via a browser on a DPS server or via a client device used by an administrator user to enable the administrator to view print queue information for a given DPS site;

FIG. 10 is a representation of a Web page that is rendered via a browser on a DPS server or via a client device used by an administrator user to enable the administrator to view completed print jobs for a selected date range for a given DPS site;

FIG. 11 is a representation of a Web page that is rendered via a browser on a DPS server or via a client device used by an administrator user to enable the administrator to view completed print jobs for a selected owner for a given DPS site;

FIG. 12 is a representation of a Web page that is rendered via a browser on a DPS server or via a client device used by an administrator user to enable the administrator to view completed print jobs for a selected printer for a given DPS site;

FIG. 13 is a representation of a Web page that is rendered via a browser on a DPS server or via a client device used by an administrator user to enable the administrator to view all completed print jobs for a given DPS site;

FIG. 14 is a representation of a Web page that is rendered via a browser on a DPS server or via a client device used by an administrator user to enable the administrator to view various completed print jobs information based on selectable search information input by the administrator;

FIG. 15 is a representation of a Web page that is rendered via a browser on a DPS server or via a client device used by an administrator user to enable the administrator to view and edit file type information pertaining to document file types supported by a given DPS site;

FIG. 16 is a representation of a Web page that is rendered via a browser on a DPS server or via a client device used by an administrator user to enable the administrator to view and file extension and corresponding application information pertaining to document file types supported by a given DPS site;

FIG. 17 is a schematic diagram illustrating a typical data flow process corresponding to a print request submitted to a driverless print server;

FIG. 18 is a combination schematic diagram and flow chart illustrating further operations and logic provided by the driverless print server software;

FIG. 19 is a flowchart and schematic diagram illustrating the operations and logic employed by a Handle Windows component to handle various dialog and message boxes that may be launched during when processing a print job; and

FIG. 20 is a schematic diagram of an exemplary computer server that may be used to host a driverless print server installation.

### DETAILED DESCRIPTION OF THE ILLUSTRATED EMBODIMENTS

A system and method for that enables users operating originating devices to print documents, images, and Web pages via a “driverless” print server (DPS) system without requiring any printing device drivers to be loaded on the originating device is described in detail herein. In the following description, numerous specific details are disclosed, to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Terminology

The following discussion discloses embodiments in accordance with the invention for implementing driverless print services, whereby originating devices may submit documents to be printed on targeted printers over both private and public networks. In accordance with the disclosed embodiments, the following terms are used:

Server: A computer running software that is accessible over a network.

Web Server: A software program running on a computer or server, which communicates with client computers using the HyperText Transmission Protocol (HTTP) to transmit HyperText Markup Language (HTML) files, Common Gateway Interface (CGI) data, and data files between the client and server computers.

Web Browser: A software application for getting and posting resources over the network, and for rendering content.

Universal Resource Locator (URL): A HTTP address string of a resource on a network. This is usually a Web page or document file.

Source Data: The source data in this document refers to any document or media that can be retrieved and output to a device. The supported input data formats include but are not limited to most of the document processor supported types (e.g. PDF, PostScript, Microsoft Word), Web URL link, e-mail, or e-mail attachment.

Job Request: This refers to a request that a user submits to the system to be processed and sent to an Output Device.

Job Status: This refers to the status of a job request that indicates the current progress of the request processing. It is a mechanism to help users understand the status of their job requests and to help the system administrators to administer them.

Printer: A hardware device that takes an electronic stream of data and creates an image on media such as paper (e.g., a hard copy output of a document).

Windows Printer: In the Microsoft Windows Operating systems, a ‘Printer’ is defined as the named combination of a printer driver, print processor, language monitor, and port monitor.

Spool File: A printer language file that is created by a MS Windows printer driver. The content of this file is sent directly to the printer for printing.

Internet Printing Protocol (IPP): A protocol similar to HTTP for sending spool files to, and getting print job status from, a networked printer.

Line Printer Remote (LPR): A protocol for submitting spool files to a networked printer.

Infrastructure Overview

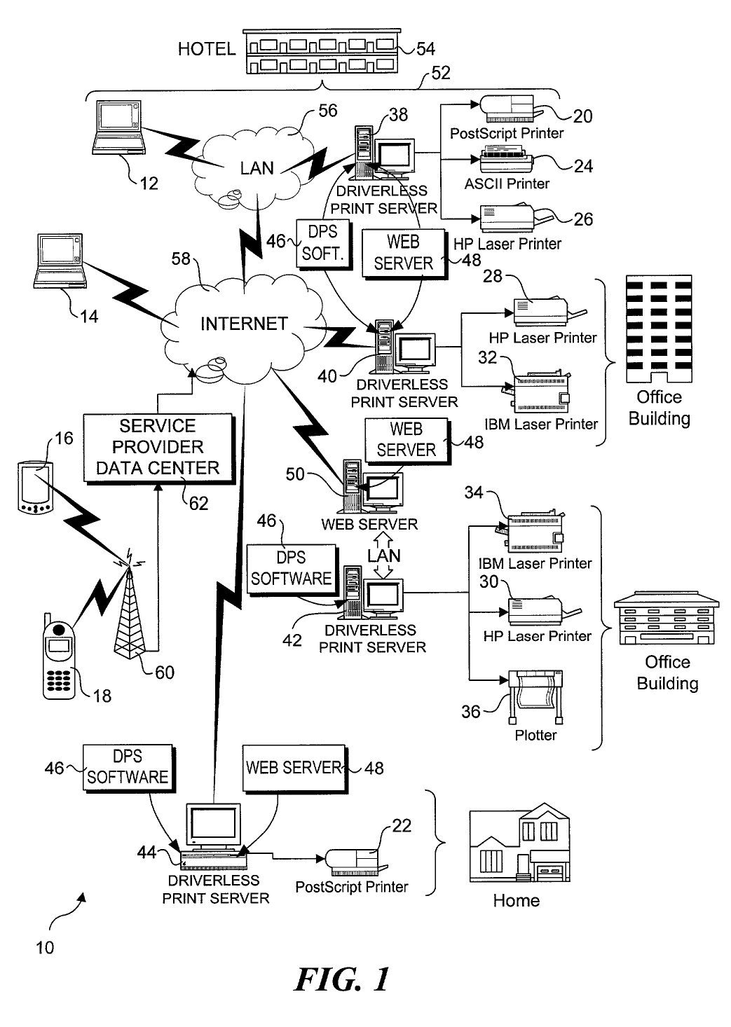

An overview of a network infrastructure 10 corresponding to an exemplary implementation of the invention is shown in FIG. 1. Network infrastructure 10 depicts four originating devices, including laptop computers 12 and 14, a PDA 16, and a cell phone 18. It will be understood that an originating device may include any device that may access a computer network via a network browser, including but not limited to PC's, workstations, laptop computers, PDA's, pocket PC's, cell phones, wireless two-way pagers (e.g., Blackberry devices), and Web TV appliances. Each of the originating devices may access any target printed that is supported by a Driverless Print Server site and may be linked in communication with an originating device via a network connection. Such target printers depicted in FIG. 1 include PostScript printers and 22, an ASCII printer 24, Hewlett-Packard (HP) laser printers 26, 28, and 30, IBM laser printers 32 and 34, and a plotter 36. In general, any type of printer or plotter may be used as a target printer. As such, the printers and plotter in FIG. 1 are for illustrative purposes only, and are not meant to limit the types of printers that may be implemented in accordance with the invention.

Each target printer will be connected to a Driverless Print Server computer, as depicted by Driverless Print Server computers 38, 40, 42 and 44. A Driverless Print Server computer comprises a set of DPS software modules 46 (also referred to herein a the Driverless Print Server or the Driverless Print Server software) operating on a computing device, such as a PC, workstation, laptop, or computer server. As described in further detail below, the Driverless Print Server software in combination with Web server 48 provides an interface by which an originating device can print to any printer linked in communication with the computing device hosting the DPS software and supported by the software. In general, Web server 48 may run on the same device as the DPS software, as illustrated by Driverless Print Server computers 38, 40, and 44, or may run on a separate machine, such as a Web server computer 50, as will be recognized by those skilled in the art.

As shown by a grouping bracket 52, laptop computer 12, Driverless Print Server computer 38, and printers 20, 24, and 26 are depicted to reside at a common physical location, such as a hotel 54. In a typical “hospitality” implementation, a printing service provider, such as a hotel, airport, copy center, etc., may provide a local area network (LAN) that allows originating devices to connect to a Driverless Print Server and associated printers provided by the hospitality site, such as LAN 56. In this instance, Web server 48 may function as an Intranet site. In other situations, an originating device may connect to a Driverless Print Server computer via Internet 58. In these instances, Web server 48 will function as an Internet Web server that supports one or more corresponding Internet Web sites.

As illustrated in FIG. 1, typical DPS sites also include office and home sites. In instances in which the DSP host computer comprises a mobile computer, the DPS site may be located anywhere there is an appropriate network connection.

In the case or wireless devices such as PDA 16 and cell phone 18, the wireless device will typically be connected to the Internet via a cellular network 60 that will include a service provider data center 62 that enables wireless access to Web sites via Internet 58. Depending on the services provided by the cellular carrier used to establish the wireless Internet link, web navigation may be supported through a translation service, or require direct wireless device support. For example, in the United States, WAP (wireless application protocol) -enabled wireless devices typically provide browsers that are designed to receive data via WML and/or HDML (wireless markup languages that are a variation of HTML designed for wireless devices). In Asia, i-mode devices use a variation of HTML called cHTML. Typical translation services may parse the HTML for a given website and produce appropriate WML to enable site navigation, thereby allowing a WAP-enabled device to browse Web sites. In addition, a growing number of Web sites directly support WAP and/or i-mode devices, thereby allowing wireless devices to browse those sites without requiring translation services.

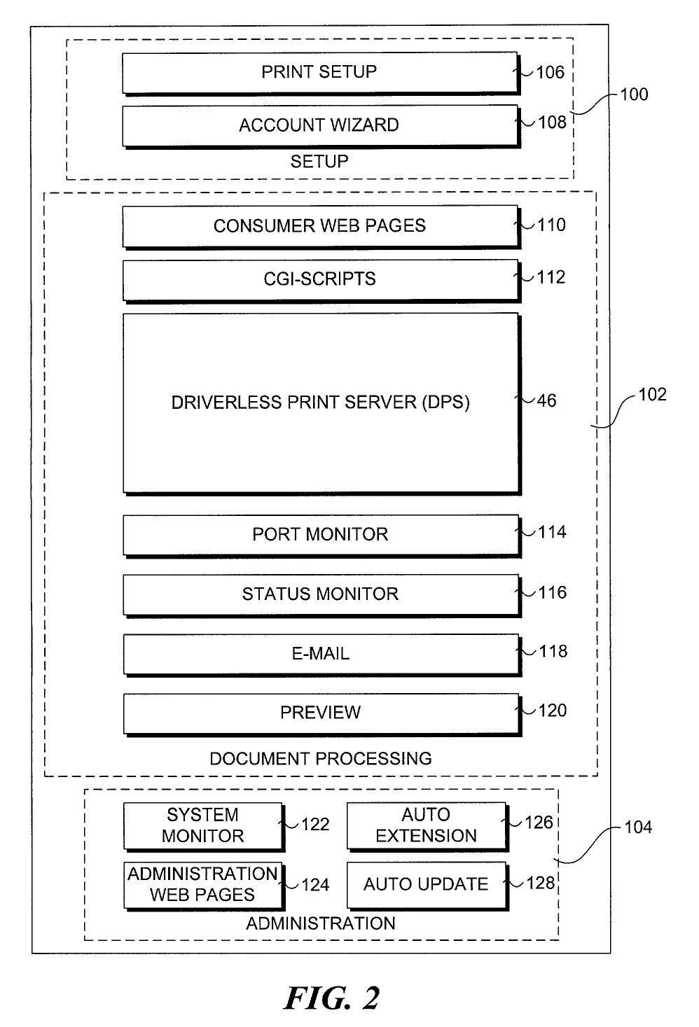

Further details of one embodiment of the software components by which the invention may be implemented are shown in FIG. 2. The software components are logically divided into three groups, including a setup component 100, a document processing component 102, and an administration component 104. Each of these components further include a plurality of software applications, scripts, components and/or modules. Setup component 100 includes a Print Setup module 106 and an Account Wizard module 108. Document processing component 102 includes consumer web pages, CGI scripts 112, a Driverless Print Server module 46, a Port Monitor 114, a Status Monitor 116, an E-mail module 118, and a Preview module 120. Administration component 104 includes a System Monitor 122, Administration (control panel) Web pages 124, an Auto Extension module 126, and an Auto Update module 128.

In one embodiment, Print Setup module 106 comprises a Microsoft (MS) Windows application run by a system administrator to change the configuration of a Windows Printer that is used by the system. The application may be used to convert an existing printer, install a new printer, or delete a printer. Conversion of an existing printer comprises taking an existing printer installation and replacing the operations provided by MS Window's port monitor with Port Monitor 114. The use of Port Monitor 114 allows the spool file to be manipulated by the DPS system and allows Status Monitor 116 to send the spool file to a selected target printer.

Print Setup module 106 may also be used to install a new printer with an appropriate printer device driver. For example, an administrator can set up a postscript printer by installing an Adobe PostScript™ driver for use with the DPS system by using the printer's PostScript Printer Description (PPD) file. If the administrator can provide a PDD, the printer setup module will install the PostScript driver and configure it for use by the DPS system. In other cases, the administrator may provide appropriate printer device driver software for the new printer.

Print Setup module 106 may also be used to delete a printer. In such an event, the Windows port monitor can be restored as the system's port monitor or a DPS server's support for a selected printer can be completely removed.

Account Wizard module 108 applies security to a set of Administrative Control Panel Web page files so that the administrator's login will determine which set of Web pages are accessible. In one embodiment, the system implements three administrative levels, including monitor, manager, and administrative levels. In one embodiment, the account wizard creates these three groups as MS Windows user groups. Furthermore, the account wizard creates MS Windows user accounts and places them into one of the administrative user groups. In one embodiment, Account Wizard module 108 is a MS Windows application.

Consumer Web pages 110 provide the user interface for consumer users (i.e., operators of the originating devices) via browsers operating on the originating devices. In one embodiment, the consumer web pages comprise standard HTML Web pages that are viewed by a Web browser. In another embodiment, Consumer Web pages 110 may include WML, HDML, or cHTML pages to support WAP and i-mode -enabled wireless devices such as wireless PDA's and cell phones.

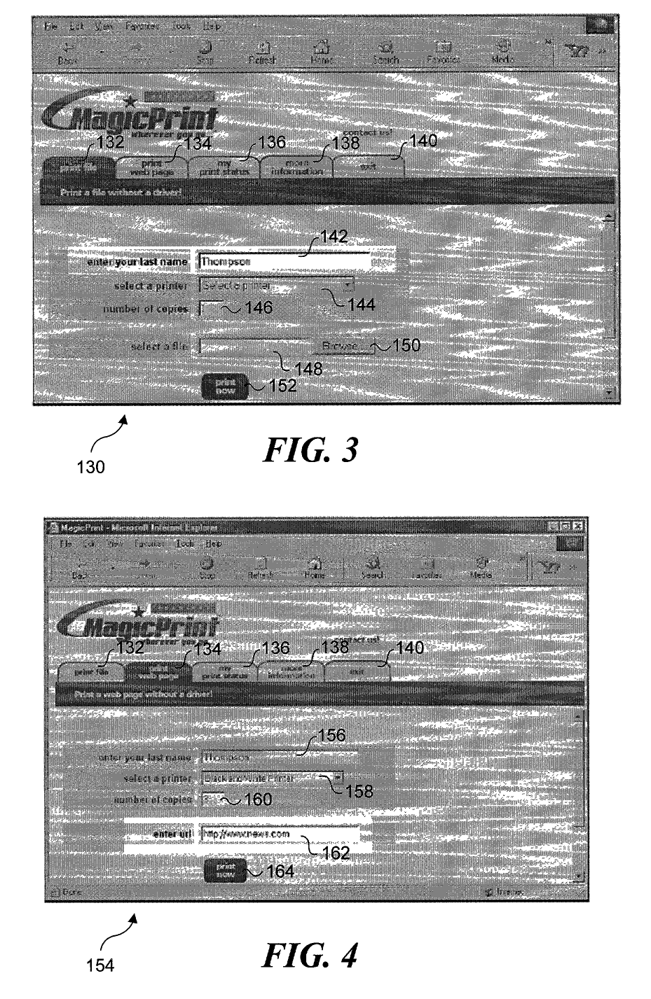

In one embodiment the Consumer Web pages include a print a file page, a print a web page page, a print job status page, a supported file types page, and help/support pages. An exemplary Consumer Web page 130 corresponding to a print a file page is shown in FIG. 3. Consumer Web page 130 includes a plurality of tabs that enable navigation to corresponding web pages, including a print file tab 132, a print web page tab 134, a my print status tab 136, a more information tab 138, and an exit tab 140.

As shown in FIG. 3, Consumer Web page 130 has print file tab 132 selected. Accordingly, the web page includes input controls that enable a consumer user to print a selected file. These controls include a last name edit box 142, a printer selection pulldown control 144, a number of copies edit box 146, a select a file edit box 148, a browse button 150, and a print now button 152. The consumer user enters his or her last name in last name edit box 142, selects a printer via pulldown control 144, and enters the number of copies via number of copies control 146. The name is used for tracking purposes, and the list of printers presented via the pulldown control will correspond to the printers supported by a given DPS site. The consumer may enter a file name corresponding to the document the consumer desires to print in select a file edit box 148, or activate browse button 150, which will bring up a conventional MS Windows browse dialog that enables the consumer to select the file by browsing directories on the originating device or a storage device to which the originating device is connected to via a network. Once all of the controls contain appropriate information, the consumer may activate print now button 152 to request the selected or entered document be printed on the selected printer. A success page (not shown) will then be presented on the browser to indicate whether the request was successfully received.

Activation of print web page tab 134 causes a Consumer Web page 154 to be rendered, as shown in FIG. 4. As before, the consumer enters his or her last name in an edit box 156, selects a printer via a pulldown control 158, and enters the number of copies desired in an edit box 3. The consumer then enters the URL for the web page desired to be printed in an edit box 162 and activates a print now button 164 to request the web page be printed on the selected printer. Again, a success page will be presented on the browser to indicate whether the request was successfully received.

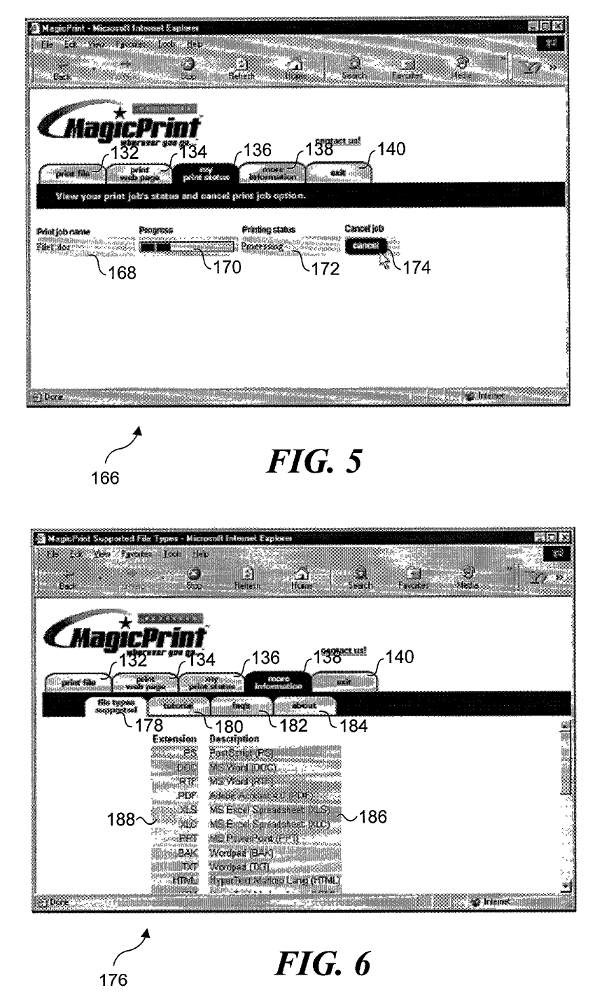

The user may review the status of a requested print job via activation of my print status tab 136, which will render a Consumer Web page 166 shown in FIG. 5. Web page 166 displays various print status information, including a print job name 168, a progress bar 170, and a printing status 172. If desired, the consumer may cancel the job by activating a cancel button 174.

Activation of more information tab 138 renders a Consumer Web page 176 shown in FIG. 6. Consumer Web page 176 includes a plurality of addition tabs, including a file type supported tab 178, a tutorial tab 180, a frequently asked question (FAQ) tab 182, and an about tab 184. In the illustrated Web page, file type supported tab 178 is activated. Activation of the file type supported tab will cause information pertaining to the file types and corresponding file descriptions to be displayed in a file type description box 186 and a file type extension box 188. In general, the list of file types will depend on the particular applications loaded on the DPS server(s) corresponding to the web site. In some instances, special print service applications may be provided for particular applications, whereby the actual application will not need to be loaded on the DPS server. For example, AutoCad files may be printed via third party print service applications that do not require a copy of the AutoCad application to be present on the DPS server.

Activation of tutorial tab 180 will cause web pages that provide tutorial information to be rendered. Similarly, activation of FAQ's tab 182 will cause a FAQ's page to be rendered that includes various frequently asked questions pertaining to how to use the DPS service and corresponding hyperlinks to the answers to each question.

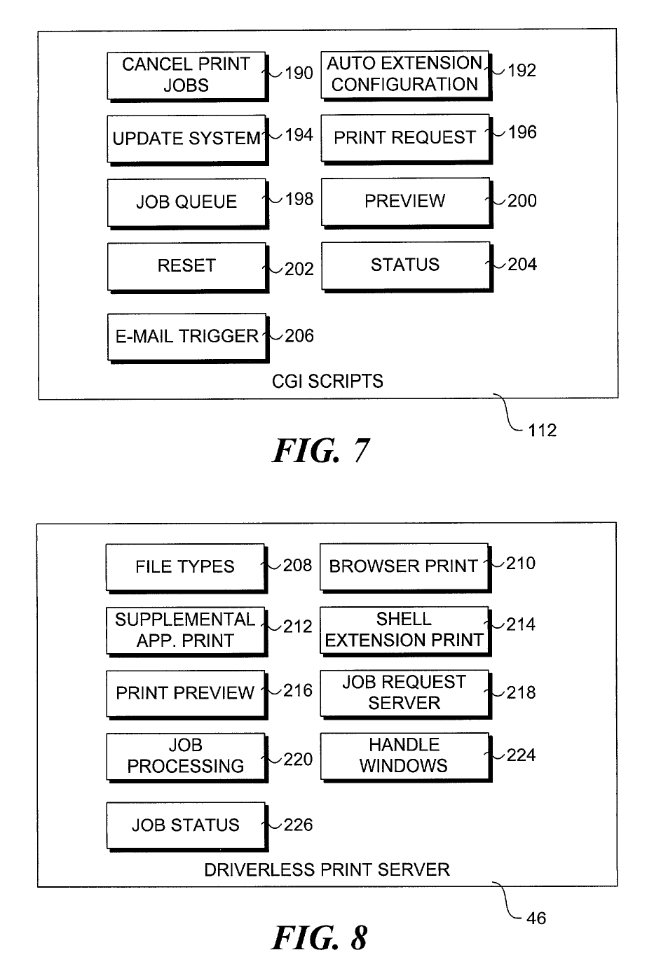

CGI Scripts 112 provide the Consumer and Administrative Panel Web pages with advanced functionality. Further details of the CGI scripts are shown in FIG. 7. A cancel print jobs CGI script 190 is used to remove a print job request from a system. From the consumer Web pages, the script can be called for any print job that is on the print job status Web page. From the administrative control panel Web pages, the script can be called for any print job that has been submitted to the system and has yet to have its spool file sent to the printer.

An automatic extension configuration CGI script 192 searches the server computer for installed applications, discovers which document types can be supported by the applications found, and configures the system to allow print job requests of the file types discovered. The results of this CGI script appear on the supported file types web page (e.g., Web page 176 of FIG. 6). An update system CGI script 194 is used to compare the installed system components against the latest available components, downloads any new components (when applicable), and installs them on the system.

A Print Request CGI script 196 takes a document file, graphical image file, or URL from the consumer Web pages as an input and creates a print job request to the system. A Job Queue CGI script 198 reads the queue of print job requests from the system and returns the list to the script's calling Web page. A Preview CGI script 200 takes a document file, graphical image file, or URL from the consumer Web pages and creates a print job request on the system in a manner similar to the print request CGI script. However, when the Preview CGI script is called, the system converts the document, image, or Web page to a format for viewing in the consumer user's Web browser rather than sending it to the printer for printing. The Preview CGI script can be called a second time for the document, image or Web page to instruct the system to send the previewed item to the printer.

A Reset CGI script 202 closes the system applications and starts them again. This script is used as a last resort attempt by the system administrator to clear any program errors that may have occurred. A Status CGI script 204 provides the Consumer and Administrative Control Panel Web pages with the progress status of a print job request. An E-mail Trigger script 206 informs the E-mail module 118 that a message has arrived for an account. E-mail module 118 uses this information to retrieve the message and convert it into a print job request.

The components implemented by Driverless Print Server 46 are shown in FIG. 8. The Driverless Print Server is the main software component for the system. It comprises an application that runs on the DPS server computer that accepts job requests, queues the requests and directs the print process for the document, image or URL from request to final printing. The Driverless Print Server includes a File Types Configuration list 208, a Browser Print component 210, a Supplemental Application Print component 212, a Shell Extension Print component 214, a Print Preview Component 216, a Job Request Server component 218, a Job Processing component 220, a Handle Windows component 224, and a Job Status component 226.

File Types Configuration list 208 is maintained by the Driverless Print Server. The configuration list has, for each file type, the extension, and the method used to print that file type. When the printing method is provided by Supplemental Application Print component 212, the list contains the path to the application used for printing, the menu commands the application uses to print, and the menu commands the application uses to close the application.

The Browser Print component 210 comprises one of three methods the Driverless Print Server uses to print. In one embodiment, this component uses the application programming interface (API) provided by the Microsoft Internet Explorer (IE) Web browser. Using the IE API, the component runs the browser within a window on the Driverless Print Server application. To print a URL, the Driverless Print Server uses the provided navigate programming interface to load a Web page into the window. Once the page is loaded, the component uses IE's provided printing programming interface to instantiate a print.

Document and image files can be printed using this method if the IE browser instance on the DPS server computer is configured with a browser plug-in for the type of document or image file requested. For example, consider the IE plug-in for Adobe Acrobat™. Adobe Acrobat document files have a PDF extension. If the Acrobat plug-in is installed on the server computer, IE's navigate programming interface allows PDF files to be loaded in IE and IE's print programming interface will allow printing of the file.

The Supplemental Application Print component 212 provides another method used by the Driverless Print Server to print. This component uses File Types Configuration list 208 to find the application associated with the file extension, load the file into the application, execute the print menu command for the application, and close the application upon completion of the printing operation. With the combination of the File Types Configuration list and the Supplemental application Print method, the system administrator can add support for additional document or image types by installing the application on the server machine and editing the File Types Configuration list.

The Shell Extension Print component 214 provides a third method used by the Driverless Print Server to print. This component uses the MS Windows Shell Extensions programming interface to print. The MS Windows Shell Extensions interface is an operating system feature that allows a user to print a document type with a command sent to the application that supports the document type. If the application supports the Shell Extension interface, the application will load the document, print it, and close itself. With the combination of the File Types configuration list and the Shell Extension Print method, the system administrator can add support for additional documents or image types by installing the application on the server machine and editing File Types configuration list 208.

The Print Preview component 216 converts the print job requested document, image or URL into a document format file so the consumer users can view an example of the requested document, image or URL. This component works in unison with Preview CGI script 200. One of the conversions the Driverless Print Server performs pertains to the Adobe Acrobat document format. Through use of the Print Preview component, the Driverless Print Server creates a spool file by the same methods it would use to create a spool file for printing. However, instead of sending the spool file to status monitor 116 for sending to the printer, it runs the spool file through the Adobe Acrobat Distiller application, which converts the document into the Acrobat PDF format. This conversion requires that the printer driver is an Adobe PostScript driver. The Driverless Print Server keeps the spool file created in the preview process so that if the consumer user wants to print the document, the DPS can simply send the spool file to status monitor 116, which will then send it to the printer for printing.

The Job Request Server component 218 takes print job requests from Print Request CGI script 196 and queues them for processing.

The Job Processing component 220 manages print job request from insertion into the job queue until the spool file is sent to the printer. This component reads the queued job requests, determines which one of the three printing methods will be used for printing, submits the document, image, or URL to the determined printing method, handles executing the print command, and submits the spool file to the status monitor for printing. During the stages of the printing process, the status is tracked and made available to any Status CGI script 204 calls that may be made.

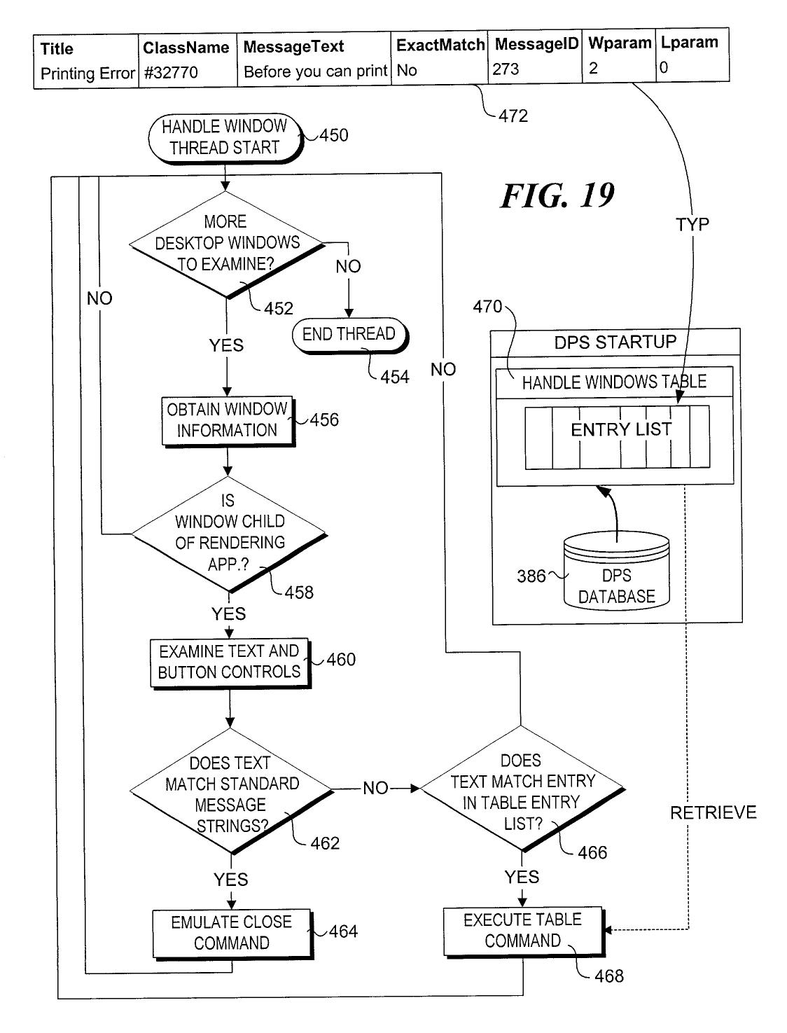

The Handle Windows component 224 is used to provide reliable printing. Many applications display message boxes and/or dialogs during the printing process to inform or gather information from the user who is requesting printing services. In order to support automatic processing of print requests, there needs to be a mechanism to respond to any message box or dialog that might appear in the application used to print the request. This mechanism is provided by Handle Windows component 224. The Driverless Print Server watches the server during the printing process for messages boxes and dialogs that might appear. When a new message box or dialog appears, the Handle Windows component reads the information, compares it with known messages or known statements, and closes the message box or dialog according to its programmed logic. Further details of the Handle Windows component are discussed below with reference to FIG. 19.

The Job Status component 226 is provided to maintain a memory-mapped file of all of the jobs in each Driverless Print Server queue. At periodic intervals, job status information is written to the memory-mapped file so that the Status CGI script can read the status of job requests.

A Port Monitor comprises a standard component in the MS Windows printing subsystem. The port monitor receives spooled data form the printer driver via the printing subsystem. A traditional port monitor is responsible for taking the spooled data from the printer driver and delivering it to the printer. In the Driverless Print Server system, Port Monitor module 114 (FIG. 2) writes the spooled data to a file. Once the entire spool file has been written to a file, Port Monitor module 114 messages the Driverless Print Server with the name and location of the spooled file.

Status Monitor 116 comprises an application that runs on the server computer. It performs a plurality of functions, but it is primarily responsible for sending spool files to printers. After the Driverless Print Server is messaged form Port Monitor 114 with the location of a spool file, the Driverless Print Server messages Status Monitor 116 with the location of the spool file, the URL of the printer where the spool file should be send, and protocol information for sending the spool file to the printer. Status Monitor 116 creates a queue for each requested printer URL. Since the printer can only receive one spool file at a time, it serializes the spool file transmittals. Status Monitor 116 can create and maintain multiple queues simultaneously.

After the spool file has been successfully sent to the printer, Status Monitor 116 messages the Driverless Print Server that the job is complete. The job history is updated, and the job is removed from the Driverless Print Server queue. Status Monitor 116 can be configured to send a message to external systems before or after the spool file has been sent to the printer. An example of an external system might be a hotel billing system, which could use the information to apply a charge to a guest's bill.

The E-mail component 118 creates a virtual e-mail address for a printer. The consumer user sends an e-mail to the printer to have it print the content of the e-mail. E-mail component 118 comprises an application that runs on the server computer. In one embodiment, E-mail component 118 uses Post Office Protocol 3 (POP3) e-mail servers to retrieve e-mail messages and insert them into the Driverless Print Server queue. In essence, the e-mail component comprises a connection between an e-mail account and the DPS server computer. Setting up an account in the e-mail component consists of entering the POP3 server URL, user name, and password of the e-mail account to use for the printer, then entering the Driverless Print Server printer to use for the e-mail account.

E-mail component 118 has two operational modes: polling and triggered. When the polling mode is used, the POP3 e-mail server is checked periodically for available e-mail messages. When the triggered mode is used, the POP3 e-mail server is checked for available messages when e-mail trigger CGI script 206 informs the e-mail component that a message is available. When a new e-mail message is available, e-mail component 118 downloads the e-mail content, including attachments, from the POP3 server. A print job request is created on the system for the text of the e-mail and for each attachment in the e-mail. A notification of submittal is returned in the form of a reply e-mail when the print job request are made and when the entire contents of the e-mail have finished printing.

System Monitor component 122 comprises an application that monitors all the other system components, watching for failures and listening for specific requests. When print job requests arrive from Print Request CGI script 196, if the Driverless Print Server application is not running, the Print Request CGI script can request that System Monitor 122 start the Driverless Print Server, thus allowing the print job request. System Monitor 122 periodically sends messages to the Driverless Print Server to get the status of the program and any print jobs in its queue. If the System Monitor detects a failure, it will clear the problem.

System Monitor 122 may also be used to download and install newer system components. It collects the version numbers of all components in the system and sends them to a system's Update Web site. If the Update Web site replies with information about the availability of newer components, it will retrieve those components and install them on the system. The System Monitor accepts update requests from its menus or from Update System CGI script 194.

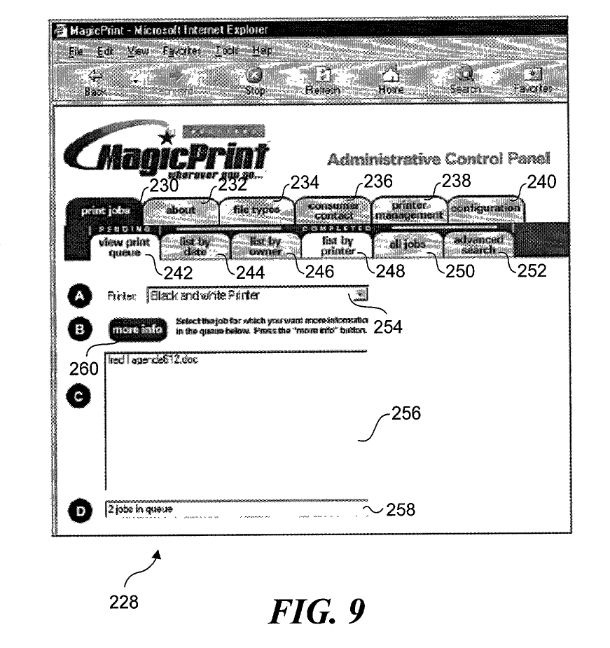

Administrative Web pages 124 allow remote configuration and monitoring of a system by administrative users. A security feature is used to prevent access of these Web pages by consumer users. An exemplary Administrative Panel Web page 228 is shown in FIG. 9. Administrative Panel Web page 228 provides a plurality of top level tabs for navigating to Administrative Web pages corresponding to the tabs, including a print jobs tab 230, an about tab 232, a file types tab 234, a consumer contact tab 236, a printer management tab 238, and a configuration tab 240.

Activation of print jobs tab 230 causes a lower set of tabs to be rendered, as shown in FIG. 9. These include a view print queue tab 242, a list by date tab 244, a list by owner tab 246, a list by printer tab 248, an all jobs tab 250, and an advanced search tab 252. As shown in FIG. 9, activation of view print queue tab 242 enables an administrator to view pending print jobs for a printer that is selected via a pulldown control 254. The pending print jobs are displayed in a text box 256, and the number of jobs in the queue are displayed in a text box 258. Activation of a more info button 260 enables the administrator to see more information for a selected print job.

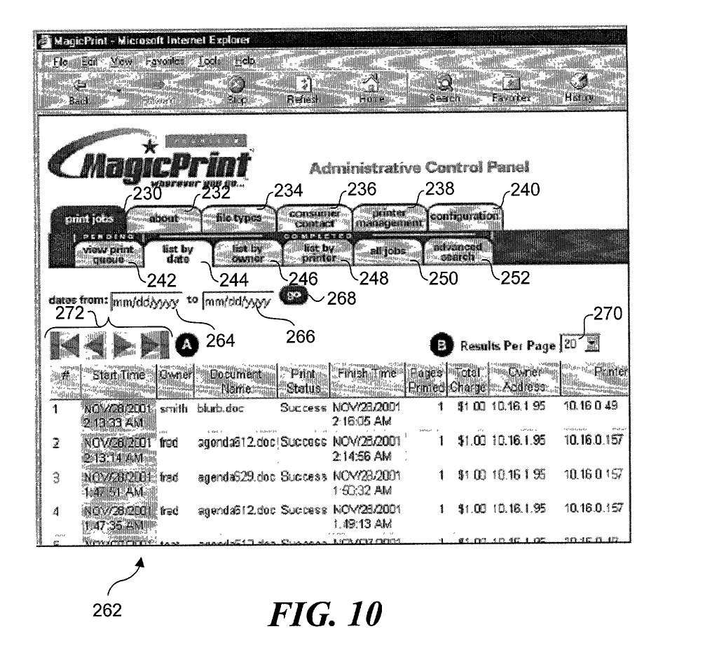

Activation of list by date tab 244, list by owner tab 246, list by printer tab 248 and all jobs tab 250 enable the administrator to view a history of print jobs pertaining to the particular tab selected. For example, activation of list by date tab 244 allows an administrator to view all print jobs for a given Driverless Print Server for a selected date range, as depicted by an Administrative Panel Web page 262 shown in FIG. 10. The administrator then enters start date and end date values via edit boxes 264 and 266 and activates a “go” button 268 to request the records for all the print jobs within the date range be retrieved. The number of results per page may be selected via a pulldown control 270, and navigation between records is enabled by a set of navigation controls 272. Each record includes information pertaining to a start time, owner, document name, print status, a finish time, number of pages printed, total charges, owner address, and printer address.

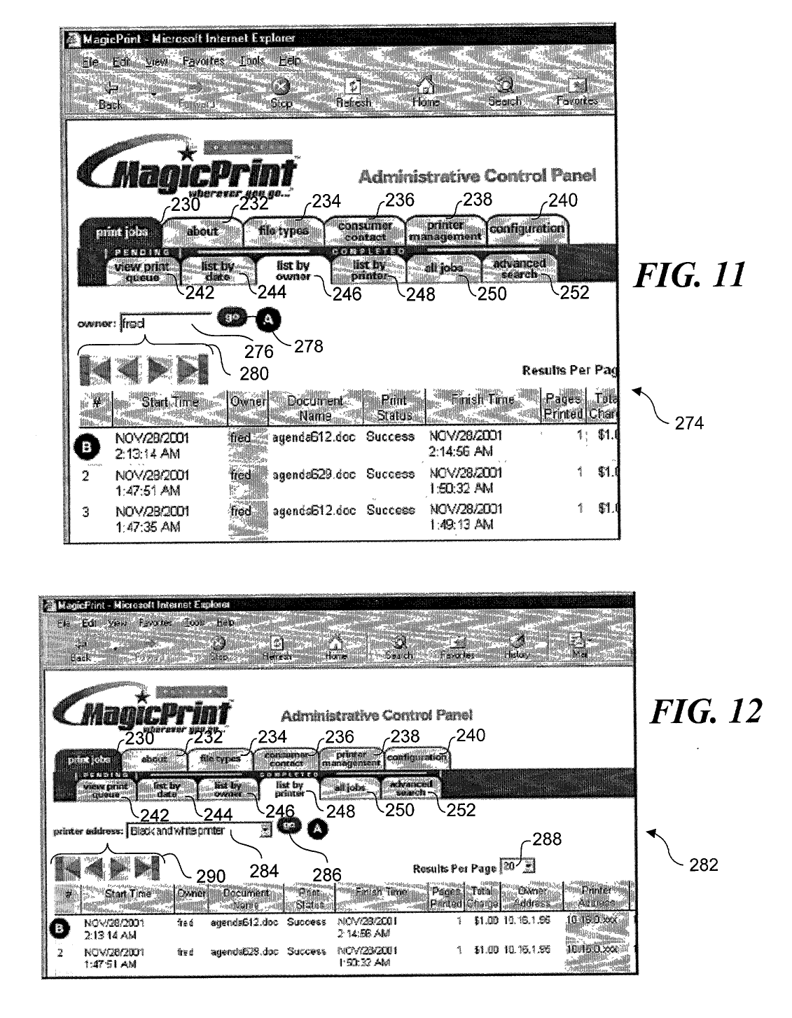

Activation of list by owner tab 246 enables the administrator to view information on all jobs submitted to a particular owner, a depicted by an Administrative Panel Web page 274 in FIG. 11. The owner may be the name of a user, the room number from which a user submitted a job, or another indicator of from whom or where the job was submitted. The owner information is entered in an edit box 276. The administrator then activates a “go” button 278 to retrieve records corresponding to the owner. As before, the number of results per page can be select via a corresponding control (not shown), and navigation between records is enabled via a navigation control set 280.

Activation of list by printer tab 248 enables the administrator to view all of the completed jobs for a selected printer, as depicted by an Administrative Panel Web page 282 in FIG. 12. The identity of the printer for which the print job history is desired is selected via a pulldown control 284, whereupon corresponding records will be retrieved in response to activation of a “go” button 286. The number of results per page may be selected via a pulldown control 288, and navigation between records is provided by a navigation control set 290.

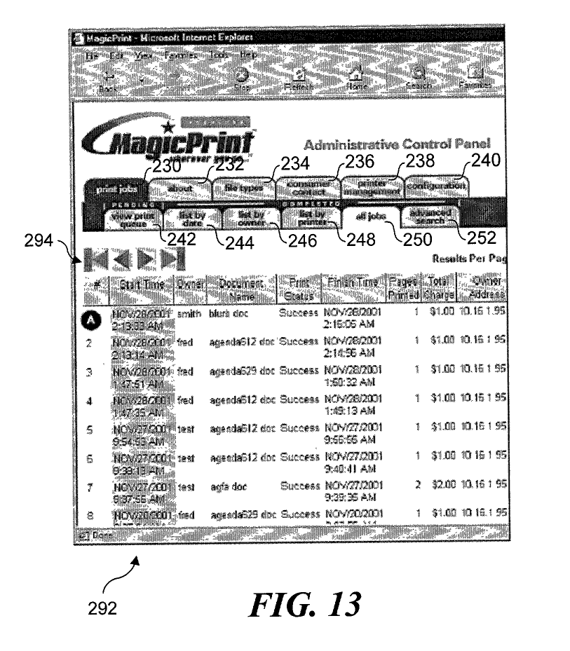

Activation of all jobs tab 250 enables the administrator to view information pertaining to all jobs printed through a particular Driverless Printer Server, as depicted by an Administrative Panel Web page 292 in FIG. 13. As before, the number of results per page may be selected via a corresponding control (not shown), and navigation between records is enabled via a set of navigation controls 294.

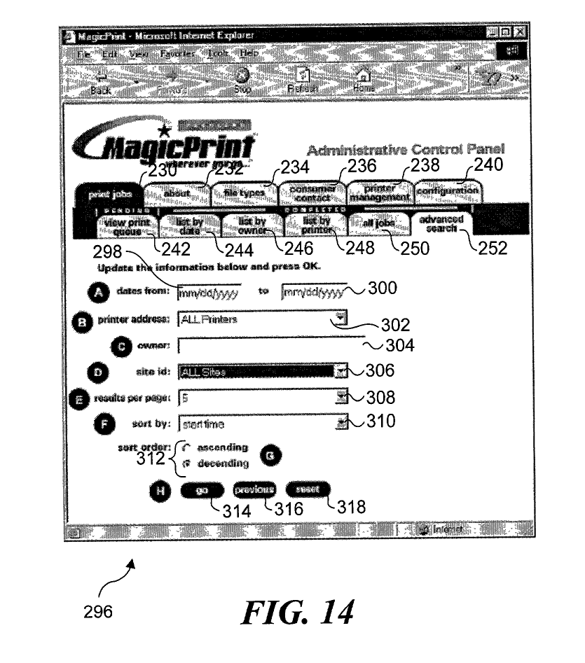

Activation of advanced search tab 252 enables the administrator to view information pertaining to print jobs that are selected based on various input values, as depicted by an Administrative Panel Web page 296 in FIG. 14. A date range for the search is entered via start and end date edit boxes 298 and 300. The printer or printer(s) may be selected via a pulldown control 302. The owner for the printer may be provided in a block 304. If no owner is specific, the search will be performed for all owners. A site identification may be selected via a pulldown control 306. The results per page may be selected via a pulldown control 308. A pulldown control 310 is provided to enable the administrator to define a column to sort by. A pair of radio buttons 312 enable the sort order to be defined as either ascending or descending. Once desired values have been entered and selected, the administrator may initiate the search via a “go” button 314. A previous set of search parameters may be retrieved via activation of a “previous” button 316, while the values for the various search parameters may be reset to default values via activation of a “reset” button 318.

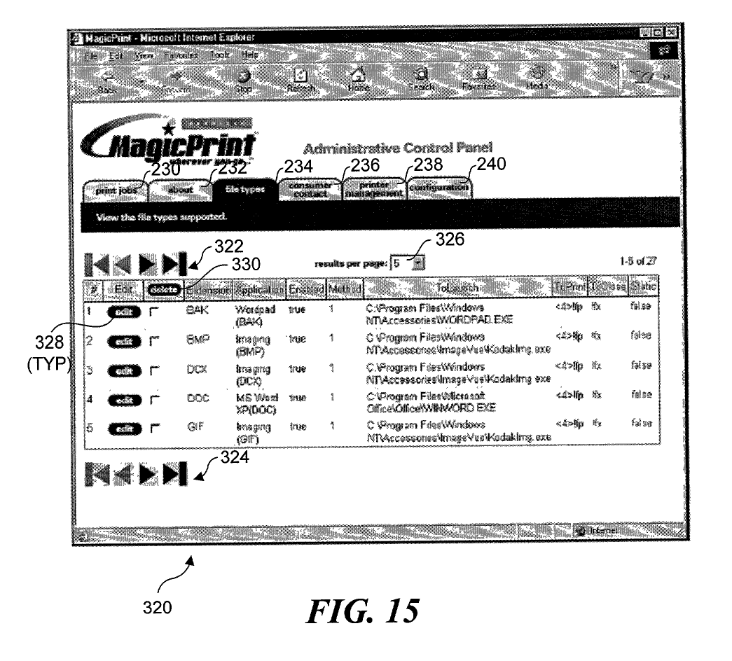

Activation of file types tab 234 enables the administrator to view and/or edit the file types for documents and image files that may be printed by the Driverless Print Server, as depicted by a Web page 320 in FIG. 15. Navigation of the various file type records is provided via an edit control set 322 and an edit control set 324. The number of records per page may be selected via a pull-down control 326. If it is desired to edit values for a particular file type, the administrator may activate an “edit” button 328 in the appropriate row, which will enable the values in the value columns to be edited. These columns include an “Extension” column, an “Application” column, and “Enabled” column, a “Method” column, a “ToLaunch” column, a “ToPrint” column, a “ToClose” column, and a “Static” column. The extension for the file type is entered in the “Extension” column. The name of the corresponding application or type of application (e.g., imaging) is entered in the “Application” column. The file path to launch the application is entered in the “ToLaunch” column. Internal commands for printing from and closing an application may be entered in the “ToPrint” column and the “ToClose” column, respectively. File type mapping information corresponding to a given row can be deleted by marking appropriate check boxes in a delete column and activating a delete button 329.

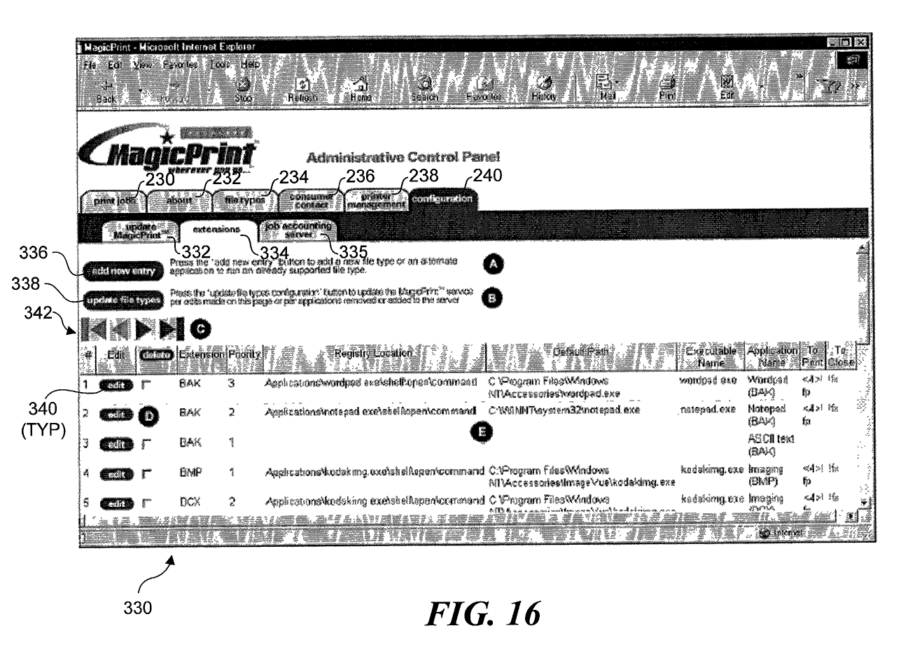

Activation of configuration tab 240 enable the administrator to update and configure the operation of a Driverless Print Server installation. As shown in FIG. 16, activation of the configuration tab loads a Web page 330 that provides three additional tabs, including an update tab 332, an extensions tab 334, and a job accounting server tab 335. Activation of extensions tab 334 launches an Extensions Web page corresponding to Web page 330.

When a file is submitted for printing, the Driverless Print Server opens an application corresponding to the file's file type. For example, if the file has a .doc extension an MS Word application will generally be opened. The application then opens the file, and through its built-in print commands, sends the submitted file to a selected printer. The extensions Web page (i.e., Web page 330) displays rows (entries) that list file type information (in an “Extension” column) and the software application corresponding to the file type (in an “Application Name” column). Each of the entries also displays a priority level for the extension (to define an order in which file types with the same extension are evaluated to determine the appropriate application for the submitted file), a Registry Location that identifies where in the OS registry information pertaining to the application is stored, a Default Path for the application, an Executable Name for the application, and internal codes to print and close the application. An administrator can add a new file type via activation of an “add new entry” button 336, which will render a Web page with corresponding edit controls for each of the columns in Web page 330 (not shown). A similar Web page is rendered in response to activation of an “update file types” button 338, only in this instance the edit controls will be filled in with values pertaining to a selected file type to be updated. Updating of a file type can also be initiated by activation of an “edit” button 340. As before, navigating between records is enabled by a set of navigation controls 342.

The Driverless Print Server uses an Extensions Table corresponding to the file type values to determine which applications installed on the server computer to use for printing files of each file type listed in the Extensions Table. The information in the table is also used to determine the location of the executable files on the server computer. In one embodiment, the Extensions Table and various other configuration and print job data is maintained in a database. Typically, the database will be hosted on the same machine as hosts the DPS software, although a separate machine may also be used to host the database, as will be recognized by those skilled in the art.

Processing a Print Request

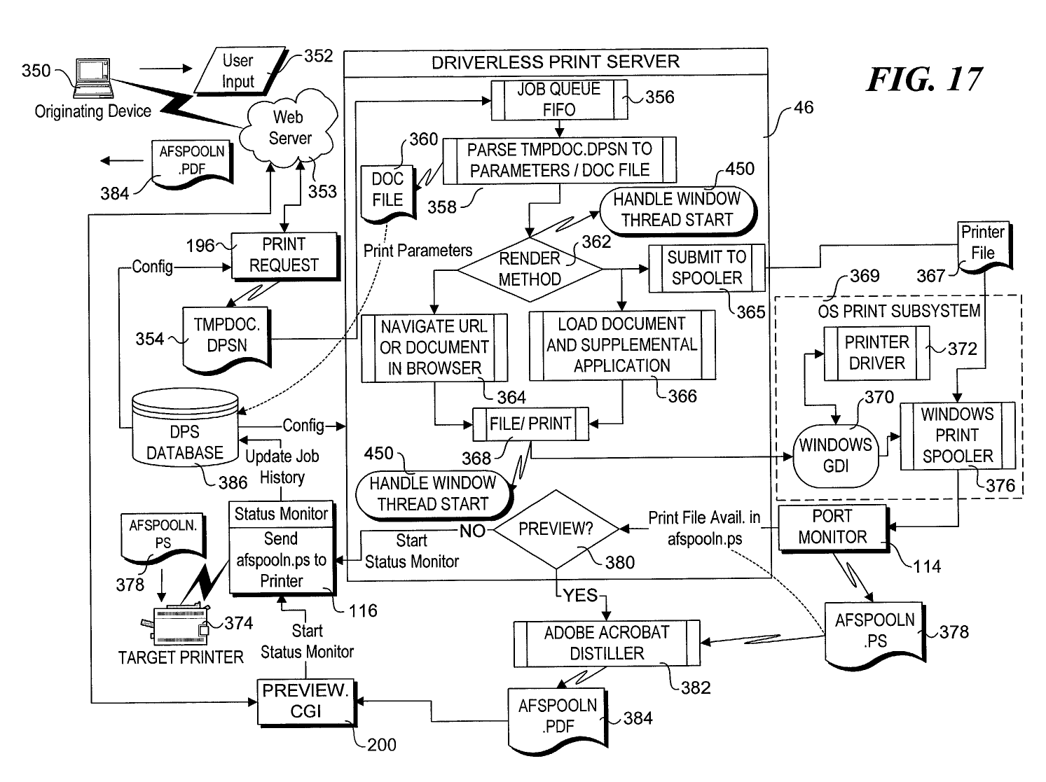

A data flow diagram that illustrates data flows and operations performed by the DPS system software components in response to a print request is shown in FIG. 17. Initially, the user of an originating device 350 will enter the URL for a driverless print server Web site (or Intranet site, if applicable) in the browser of the originating device to load the consumer user print Web page (e.g., Consumer Web page 130 of FIG. 3). The user will then enter appropriate information for printing either a document, image, or Web page as discussed above. The entered information will be enabled by ASP controls or a similar mechanism (e.g., javascript, Vbscript, etc.) contained in the Consumer Web pages that are served by the Web server component of the system, depicted as Web server 353. The user-entered data is depicted as user input 352, which is received via Web server 353 and is initially processed by Print Request CGI script 196, which generates a tmpdoc.dpsn document 354 containing print parameters and other data corresponding to the request. The Tmpdoc.dpsn document is then sent via the Print Request CGI script to a job queue 356. In one embodiment, the job queue comprises a first-in first-out (FIFO) type of job queue. Optionally, other types of job queues may also be used, as will be recognized by those skilled in the art. As discussed above, job queue operations are performed by job processing component 220.

The job queue submits job requests to be processed by the system. Each request is processed by a block 358 in which the tmpdoc.dpsn file is parsed to retrieve print job parameters corresponding to the print request, which are stored in a document file 360. For example, parsed information may include a printer selection, number of copies, identity of consumer user, document name, etc. A portion of the print job parameters are then stored in a DPS database 386.

In a decision block 362, a determination is made to what type of document was requested to be printed, e.g., an application file, an image, or a Web page URL. If the document pertains to a browsable document, such as a Web page, image or a PDF file, the logic flows to a block 364, wherein the Web page, image or PDF document is loaded via the Driverless Print Server's browser. Otherwise, the logic flows to a block 366 in which the document and an appropriate supplemental application that can be used to print the document is loaded. For example, if the document comprises a MS Excel spreadsheet, an instance of the MS Excel application is loaded, along with the Excel document. In a block 368, an internal command is generated to simulate a user requesting a print operation to request that the URL, image or document be printed by either the browser or supplemental application. For example, most applications provide a File->Print menu option that initiates a printing process for the application.

In response to an internal application or browser print request, various printing and document information is passed internally to operating system components that handle printer operations. As discussed above, in one embodiment the Driverless Print Server is operated in an MS Windows OS environment. Accordingly, this environment provides an OS print subsystem 369 including a Graphical Device Interface (GDI) component 370 that interacts with a printer device driver 372 corresponding to the selected printer to generate appropriate printer (i.e., output device) data that will be sent to a target printer 374 to produce an output document. The printer data is internally handled by an MS Windows print spooler component 376 that outputs a print spool file that is received by Port Monitor 114. In the illustrated example, it is assumed that target printer 374 comprises a PostScript printer. Accordingly, Port Monitor 114 outputs a PostScript file 378.

While the foregoing operations are going on, the user of originating device 350 may select to preview a simulated printed output of the document, image or Web page prior to having the source document printed. In a decision block 380, a determination is made to whether the user requested to preview the printer output. If the answer is YES (TRUE), in one embodiment an instance of Adobe Acrobat Distiller 382 is launched, which is used to generate an Adobe portable document format (PDF) document 384. The PDF document is then handled by Preview CGI script 200, which sends the document back to originating device 350 via Web server 353, where it is rendered on the browser running on the originating device via an Adobe PDF plug-in. The rendered display (not shown) will provide a preview of what the printed document will look like and include user interface (UI) controls that will enable the consumer user to select to have the document printed or canceled.

If the consumer user desires to have the document printed, a print notification is sent back to Web server 353, where it is processed by Preview CGI script 200. In response to receiving the print notification, Preview CGI script 200 starts Status Monitor 116 and submits the print document 378 to target printer 374. In conjunction with this event, job history information is updated in a DPS database 386.

In the event that the print preview option is not selected by the consumer user, the answer to decision block 380 is NO (FALSE), which results in starting up Status Monitor 116 and submitting print document 374 to target printer 374. During the print process, Status Monitor 116 monitors the progress of the process and updates DPS database 386. Status CGI-script 204 is used to provide Web page print status information by retrieving the progress information from the database and generating appropriate HTML to cause the progress information to be displayed in the Web page, such as shown in Web page 166 of FIG. 5.

In one embodiment, the Driverless Print Server supports direct printing of printer files. For instance, if the print job file comprises a printer file, it can be directly printed if it corresponds to a printer file type of the target printer. For example, PostScript files may be printed on PostScript printers. Similarly, printer files for other types of printers may have been previously created by selecting a “save to file” option during a print process. If the file is determined to be a printer file in decision block 362, the logic proceeds to a block 367, wherein the printer file (depicted by a printer file 369) is directly sent to Windows print spooler 376.

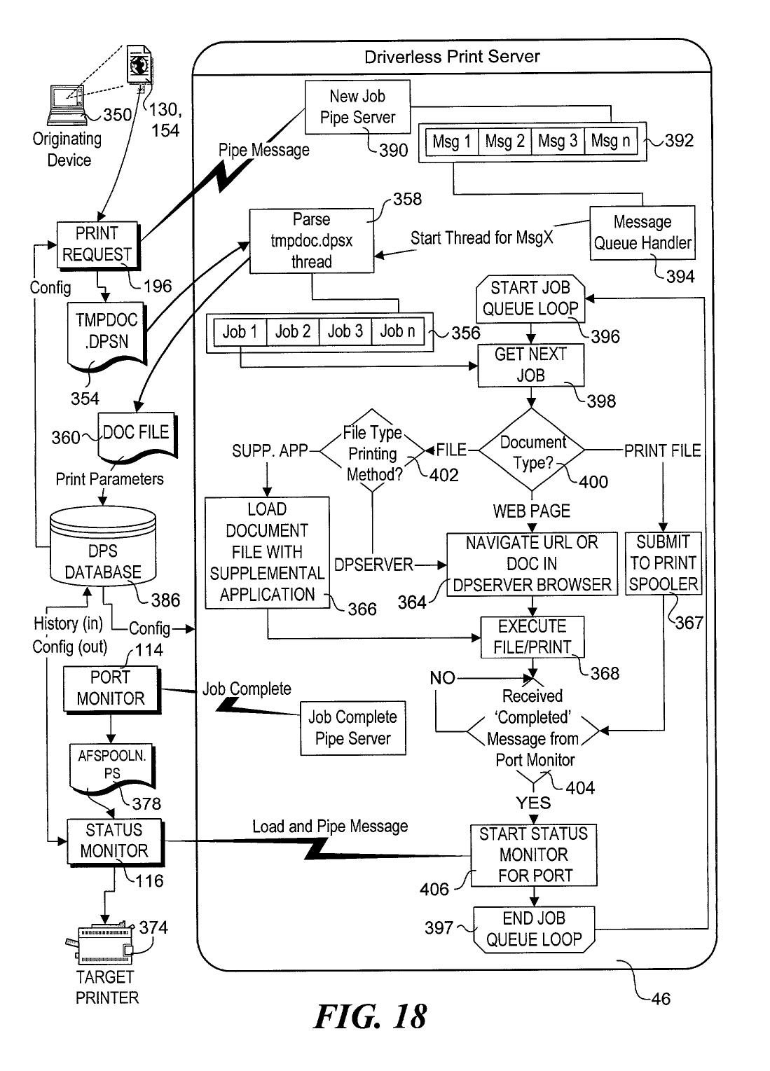

Further details of the internal operations of Driverless Print Server software 46 are shown in FIG. 18. As before, a consumer user operating originating device 350 requests to print a document or image file, or a Web page via Consumer Web pages 130 and 154, respectively. In response to activation of the “print now” button on appropriate Consumer Web page, user input data is processed by Print Request CGI script 196, which creates tmpdoc.dpsn document 354. The Print Request CGI script also pipes a message containing a print request to a New Job Pipe Server 390, which stores the messages in a message queue 392. For each print request message, a Message Queue Handler 394 starts a corresponding thread that parses the corresponding tmpdox.dpsn document 354, thereby generating document file 360 and submitting a print job to job queue 356.

As depicted by a start job queue loop block 396 and end job queue loop block 397, the following operations and logic displayed between these loop ends is performed for a print job. First, in a block 398, the next job is retrieved from job queue 356. In a decision block 400, a decision is made to what type of document the print job corresponds to. If the document is an application file, the logic proceeds to a decision block 402 in which a determination is made to what type of file type printing method should be used. If the file requires a supplemental application (e.g., MS Word, MS Excel, AutoCad, etc.), the logic proceeds to block 366 where the document and appropriate supplemental application is loaded in the manner discussed above. Once the file is loaded in the supplemental application, a file printing command is internally generated in block 368 to submit the file for printing by the OS, as before.

Next, in a decision block 404 a determination is made to whether a “Completed” message is received from Port Monitor 114. This determination is made on a periodic basis or through a software interrupt mechanism until the “Completed” message has been received. Status Monitor 116 is then started in a block 406, which sends print document 378 to target printer 374 and updates the job history data in DPS database 386, as before.

Returning to decision blocks 400 and 402, if the document type is a Web page or a file type that can be printed directly by the Driverless Print Server computer without requiring a supplemental application (e.g., a PDF document or various types of image files), the logic proceeds to block 364, wherein the DPS computer's browser is navigated to the URL for the Web page or the browser is otherwise used to render the PDF file or image file. Once rendered, the remaining print operations are performed in the manner discussed above, beginning with block 368. As discussed above, if the document type is a printer file, the document is directly sent to Windows Print Spooler 376.

A flowchart detailing the logic and operations provided by Handle Windows component 224 is shown in FIG. 19. As shown by start blocks 450 in FIG. 17, a Handle Windows thread is launched at the start of decision block 362 and immediately after the print action has been invoked in block 368. As discussed above, the Handle Windows component is used to handle various dialog and messaged boxes that may be launched when an application is loaded, when a document is loaded into an application, when a print action is initiated, during the printing process, etc.

Returning to the flowchart of FIG. 19, upon being launched, the Handle Window thread makes a determination to whether there are any more desktop windows to examine in a block 452. Such windows will generally include dialog boxes and message boxes. If there are no more windows to examine, the thread is ended, as depicted by and end thread end block 454. If there are more windows to examine, the logic proceeds to a block 456 in which window information for a window is obtained. Under MS Windows operating systems, window information may be obtained by making an appropriate Windows API call.

Next, in a decision block 458 a determination is made to whether the window is a child window of a rendering application (i.e., was it produced by a supplemental application or a browser). If the decision is no, the window does not correspond to the rendering application, and the logic proceeds to decision block 452 to evaluate the next window. If the answer to decision block 458 is Yes (TRUE), the logic proceeds to a block 460 in which text and control buttons for the window are examined.

As determined by a decision block 462, if the text matches a standard message string the logic proceeds to a block 464 in which a window close command is internally provided to emulate a user activating either a close button on the window or the window close icon in the window's frame. The logic then returns to decision block 452 to process the next window.

If the text does not match a standard message string, the answer to decision block 462 is No (FALSE), and the logic proceeds to a decision block 466 in which a determination is made to whether the text matches a corresponding an entry list MessageText value stored in a Handle Windows Table 470 in DPS database 386. If there is a matching value, the logic proceeds to a block 468 in which the table command is executed by retrieving the data in the row of the matching MessageText value and issuing a corresponding message to the Windows API based on the parameters provided by the data. For example, a typical entry list row 472 is shown at the top of FIG. 472. The row contains information pertinent to the Windows API, including a MessageID, Wparam, and Lparam value. These parameters are used to make a corresponding API call to effectuate the desired operation for handling the window. Once the table command is executed, or if the answer to decision block 466 is No (FALSE), the logic returns to decision block 452 to begin processing the next window.

In the foregoing description and accompanying drawings, embodiments of the invention that implement software operations provided by MS Windows operating system components were disclosed. This is not meant to be limiting, as the principles and teaching of the invention may be applied to implementation in which other operating systems are used, such as UNIX-based operating systems and LINUX-based operating systems. For example, various UNIX and LINUX operating systems provide graphical user interfaces, application API's and printing capabilities that are supported by OS kernel components that provide similar operations to the MS Windows printing support components discussed above (e.g., Windows GDI, print spooler, printer drivers, etc.)

### EXEMPLARY FILE SERVER COMPUTER SYSTEM

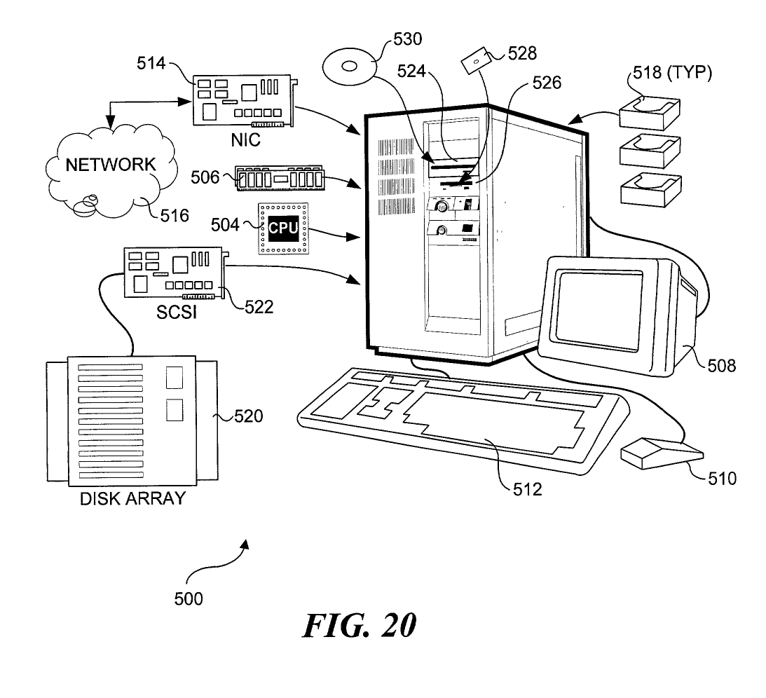

With reference to FIG. 20, a generally conventional computer server 500 is illustrated, which is suitable for use in connection with practicing the present invention, and may be used for the DPS server computer and Web server computer where a separate computer is used for performing Web server operating. Examples of computer systems that may be suitable for these purposes include computer servers operating Microsoft Windows, UNIX-based, and LINUX-based operating systems.

Computer server 500 includes a chassis 502 in which is mounted a motherboard (not shown) populated with appropriate integrated circuits, including one or more processors 504 and memory (e.g., DIMMs or SIMMs) 506, as is generally well known to those of ordinary skill in the art. A monitor 508 is included for displaying graphics and text generated by software programs and program modules that are run by the computer server. A mouse 510 (or other pointing device) may be connected to a serial port (or to a bus port or USB port) on the rear of chassis 502, and signals from mouse 510 are conveyed to the motherboard to control a cursor on the display and to select text, menu options, and graphic components displayed on monitor 508 by software programs and modules executing on the computer. In addition, a keyboard 512 is coupled to the motherboard for user entry of text and commands that affect the running of software programs executing on the computer. Computer server 500 also includes a network interface card (NIC) 514, or equivalent circuitry built into the motherboard to enable the server to send and receive data via a network 516.

File system storage corresponding to the invention may be implemented via a plurality of hard disks 518 that are stored internally within chassis 502, and/or via a plurality of hard disks that are stored in an external disk array 520 that may be accessed via a SCSI card 522 or equivalent SCSI circuitry built into the motherboard. Optionally, disk array 520 may be accessed using a Fibre Channel link using an appropriate Fibre Channel interface card (not shown) or built-in circuitry.

Computer server 500 generally may include a compact disk-read only memory (CD-ROM) drive 524 into which a CD-ROM disk may be inserted so that executable files and data on the disk can be read for transfer into memory 506 and/or into storage on hard disk 518. Similarly, a floppy drive 526 may be provided for such purposes. Other mass memory storage devices such as an optical recorded medium or DVD drive may also be included. The machine instructions comprising the software programs, components, and modules that causes processor(s) 204 to implement the operations of the present invention that have been discussed above will typically be distributed on floppy disks 528 or CD-ROMs 530 (or other memory media) and stored on one or more hard disks 518 until loaded into memory 506 for execution by processor(s) 504. Optionally, the machine instructions may be loaded via network 516 as a carrier wave file.

Although the present invention has been described in connection with a preferred form of practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

What is claimed is:

1. A method to enable a user of an originating device to print source data on a target printer, comprising:
providing data to the originating device from which a user interface can be rendered to enable the user to select the source data to print and identify the target printer;
receiving the source data or indicia identifying the source data from the originating device and providing the source data or indicia to a print server;
loading the source data into a corresponding application or browser running on the print server;
generating printer data corresponding to the source data via the corresponding application or browser and a print subsystem of an operating system running on the print server; and
submitting the printer data from the print server to the target printer.

2. The method of claim 1, wherein the originating device comprises one of a personal computer (PC), laptop computer, workstation, computer server, personal digital assistant device, pocket PC, cellular phone, or Internet appliance.

3. The method of claim 1, wherein the originating device does not require a printer device driver corresponding to the target printer to be loaded on it.

4. The method of claim 1, wherein the source data corresponds to an application file, and the originating device does not require an application corresponding to the application file to be loaded on it.

5. The method of claim 1, wherein the data provided to generate the user interface comprises a set of Web pages served by a Web server that is operatively linked in communication with the print server.

6. The method of claim 1, wherein the source data comprises an application file.

7. The method of claim 1, wherein the source data comprises an image file.

8. The method of claim 7, wherein the image file is rendered on a browser running on the print server and a print action is invoked to cause the browser to submit graphical data pertaining to the image to the print subsystem.

9. The method of claim 1, wherein the source data comprises a Web page.

10. The method of claim 9, wherein the indicia identifying the source data comprises a URL (uniform resource locator) address corresponding to the Web page, and the URL address is used by the browser to navigate to the Web page.

11. The method of claim 1, further comprising providing print status information in the user interface to enable the user to monitor a source data print request submitted by the user.

12. The method of claim 1, further comprising:
defining file type-to-application mapping information that maps each of a plurality of source data file types to one or more corresponding applications that may be used to print source data having that file type; and
in response to receiving the source data at the print server,
determining a file type of the source data;
determining an appropriate application to load on the print server to print the source data;
initiating a print action to cause the application in combination with the print subsystem to generate the printer data; and
routing the print data to the target printer to be printed.

13. The method of claim 12, further comprising providing a user interface to enable an administrator to define the file type-to-application mapping information and define application loading information to enable the applications to be loaded on the print server.

14. The method of claim 13, wherein the user interface comprises a web page served from a web server operatively coupled to the print server.

15. The method of claim 12, wherein an application may display message boxes and/or dialogs during an application printing process to inform a user of an error or warning or gather print parameter information from a user, further comprising automatically providing computer-generated input to handle any message boxes and/or dialogs launched by the application to generate the printer data.

16. The method of claim 1, further comprising providing print preview data to the originating device that comprising a simulated representation of an output of the target printer when rendered on the originating device.

17. The method of claim 1, further comprising providing a Web-based user interface that enables an administrator to view information pertaining to pending print jobs.

18. The method of claim 1, further comprising providing a Web-based user interface that enables an administrator to view information pertaining to completed print jobs.

19. The method of claim 18, wherein the Web-based user interface enables the administrator to view completed print request using a filter based on at least one of a date range, a specified owner, an account, and a specified printer.

20. The method of claim 18, wherein the Web-based user interface enables the administrator to view completed print requests using a filter that is generated in response to a plurality of search criteria entered by the administrator view the Web-based user interface.

21. The method of claim 1, wherein the source data comprises a file that the user is enabled to select via a file browse operation, said file comprising a file that is either stored on the originating device or stored on a device that may be accessed by the originating device via a network.

22. The method of claim 1, wherein the operations of loading the source data and generating the printer data are performed using an operating system shell extension print mechanism.

23. A machine readable media on which a plurality of machine instructions are stored that when executed by a computing machine enable a user of an originating device to print a hard copy output on a target printer pertaining to source data selected by the user by performing the operations of:
serving Web-based data from a Web server to the originating device to enable a user interface to be rendered on the originating device, said user interfaced having interactive controls to enable the user to select the source data to print and identify the target printer from a list of printers that may be selected to print the hard copy output;
receiving the source data or indicia identifying the source data from the originating device at the Web server;
passing the source data or indicia identifying the source data to a print server;
loading the source data into a corresponding application or browser running on the print server;
initiating a print action to cause printer data corresponding to the source data to be generated by the corresponding application or browser and a print subsystem of an operating system running on the print server; and
submitting the printer data from the print server to the target printer.

24. The machine-readable media of claim 23, wherein the originating device comprises one of a personal computer (PC), laptop computer, workstation, computer server, personal digital assistant device, pocket PC, cellular phone, or Internet appliance.

25. The machine-readable media of claim 23, wherein the source data comprises an application file.

26. The machine-readable media of claim 25, wherein the source data comprises an application file that the user is enabled to select via a file browse operation initiated by a corresponding control in the rendered user interface, said application file comprising a file that is either stored on the originating device or stored on a device that may be accessed by the originating device via a network.

27. The machine-readable media of claim 23, wherein the source data comprises an image file that is rendered on a browser running on the print server and a print action is executed by the browser to submit graphical data pertaining to the image to the operating system print subsystem.

28. The machine-readable media of claim 23, wherein the indicia identifying the source data comprises a URL (uniform resource locator) address corresponding to a Web page, and execution of the machine instructions further performs the operations of:
loading a Web browser;
passing the URL address to the Web browser so that the Web browser can navigate to the Web page;
activating a print operation provided by the Web browser to cause printer data corresponding to the Web page to be generated by the browser in combination with the print subsystem.

29. The machine-readable media of claim 23, wherein execution of the machine instructions further performs the operation of serving an interactive Web page providing print status information to enable the user to monitor a source data print request submitted by the user.

30. The machine-readable media of claim 23, wherein execution of the machine instructions further performs the operations of:
providing a user interface to enable an administrator to define file type-to-application mapping information that maps each of a plurality of source data file types to one or more corresponding applications that may be used to load source data having that file type; and
in response to receiving the source data at the print server,
determining a file type of the source data;
determining an appropriate application to load on the print server to print the source data; and
initiating a print action to cause the application in combination with the print subsystem to generate the printer data.

31. The machine-readable media of claim 23, wherein execution of the machine instructions further performs the operation of providing a user interface to enable an administrator to define the file type-to-application mapping information and define application loading information to enable the applications to be loaded on the print server.

32. The machine-readable media of claim 31, wherein the user interface comprises a web page served from the web server.

33. The machine-readable media of claim 30, wherein an application may display message boxes and/or dialogs during an application printing process to inform a user of an error or warning or gather print parameter information from a user, and wherein execution of the machine instructions further performs the operation of automatically providing computer-generated input to handle any message boxes and/or dialogs that are launched by the application to generate the printer data.

34. The machine-readable media of claim 23, wherein execution of the machine instructions further performs the operation of generating print preview data corresponding to a print preview of the hard copy output and sending the print preview data to the originating device to be rendered on the originating device.

35. The machine-readable media of claim 34, wherein the data is sent to the originating device as a portable document format (PDF) document.

36. The machine-readable media of claim 23, wherein execution of the machine instructions further performs the operation of serving Web pages from the Web server to enable an administrator to view information pertaining to pending print jobs.

37. The machine-readable media of claim 23, wherein execution of the machine instructions further performs the operation of serving administration Web pages from the Web server to enable an administrator to view information pertaining to completed print jobs.

38. The machine-readable media of claim 37, wherein the administration Web pages enable the administrator to view completed print requests using a filter based on at least one of a date range, a specified owner, an account, and a specified printer.

39. The machine-readable media of claim 37, wherein the administration Web pages enable the administrator to view completed print requests using a filter that is generated in response to a plurality of search criteria entered by the administrator.

40. The machine-readable media of claim 23, wherein the operations of loading the source data and generating the printer data are performed using an operating system shell extension print mechanism.

41. A system to enable a user of an originating device to print source data on a target printer, comprising:
Web server means for serving one or more interactive Web pages to enable the user to select the source data to print and identify the target printer via a browser running on the originating device that renders the interactive Web page(s) and to receive a print request that includes the source data or indicia identifying the source data and identifies the target printer;
means for passing the source data or indicia identifying the source data from the Web server means to a print server computer;
means for loading an application or browser from which the source data can be printed on the print server computer along with the source data;
means for generating a print request to cause the application or browser to in combination with a print subsystem of an operating system running on the print server computer to generate printer data pertaining to the source data and the target printer; and
means for sending the printer data from the print server computer to the target printer.

42. The system of claim 41, wherein the originating device comprises one of a personal computer (PC), laptop computer, workstation, computer server, personal digital assistant device, pocket PC, cellular phone, or Internet appliance.

43. The system of claim 41, wherein the source data comprises one of an application file, image, or a Web page.

44. The system of claim 41, wherein the source data comprises an application file that the user is enabled to select via a file browse operation initiated by a corresponding control in an interactive Web page served by the Web server means, said application file comprising a file that is either stored on the originating device or stored on a device that may be accessed by the originating device via a network.

45. The system of claim 41, wherein the source data comprises an image file that is rendered on a browser running on the print server computer and the means for generating a print request invokes a browser print command to cause the browser to submit graphical data pertaining to the image to the print subsystem.

46. The system of claim 41, wherein the indicia identifying the source data comprises a URL (uniform resource locator) address corresponding to a Web page, and the means for loading an application or browser loads a Web browser and passes the URL address to the Web browser so that the Web browser can navigate to the Web page, and the means for generating a print request activates a Web browser print command to cause the Web browser to send data corresponding to the Web page to the print subsystem to generate the printer data.

47. The system of claim 41, wherein the Web server means further performs the operation of serving an interactive Web page providing print status information to enable the user to monitor a source data print request submitted by the user.

48. The system of claim 41, wherein the Web server means further performs the operations of:
serving one or more Web pages to enable an administrator to define file type-to-application mapping information that maps each of a plurality of source data file types to one or more corresponding applications that may be used to load source data having that file type; and
in response to receiving t he source data at the print server computer, the means for loading an application or browser performs the operations of:
determining a file type of the source data;
determining an appropriate application to load on the print server computer to open the source data; and
the means for generating a print request invokes an application print command to cause the application to submit data corresponding to the source data to the print subsystem to generate the printer data.

49. The system of claim 48, wherein said one or more Web pages further enable an administrator to define the file type-to-application mapping information and define application loading information to enable the applications to be loaded on the print server computer.

50. The system of claim 48, wherein an application may display message boxes and/or dialogs during an application printing process to inform a user of an error or warning or gather print parameter information from a user, further comprising a handle windows means that automatically provides computer-generated input to handle any message boxes and/or dialogs that are invoked when generating the printer data.

51. The system of claim 41, further comprising a print preview means that generates data that may be used to render a print preview of what the hard copy output will look like.

52. The system of claim 51, wherein the data to render the print preview comprises a portable document format (PDF) document.

53. The system of claim 41, wherein the Web server means further serves administration Web pages to enable an administrator to view information pertaining to pending print jobs.

54. The system of claim 41, wherein the Web server means further serves administration Web pages to enable an administrator to view information pertaining to completed print jobs.

55. The system of claim 54, wherein the administration Web pages enable the administrator to view completed print requests using a filter based on at least one of a date range, a specified owner, an account and a specified printer.

56. The system of claim 54, wherein the administration Web pages enable the administrator to view completed print requests using a filter that is generated in response to a plurality of search criteria entered by the administrator.

57. A method to enable a user of an originating device to print source data on a target printer, comprising:
providing data to the originating device from which a user interface can be rendered to enable the user to select the source data to print and identify the target printer;
receiving the source data from the originating device and providing the source data to a print server;
determining whether the source data comprises a printer file, and if it does,
submitting the source data to a print spooler; and
routing an output of the print spooler to the target printer.

58. The method of claim 57, wherein the data provided to generate the user interface comprises a Web page served by a Web server that is operatively linked in communication with the print server.

59. A machine readable media on which a plurality of machine instructions are stored that when executed by a computing machine enable a user of an originating device to print a hard copy output on a target printer pertaining to source data selected by the user by performing the operations of:
serving Web-based data from a Web server to the originating device to enable a user interface to be rendered on the originating device, said user interfaced having interactive controls to enable the user to select the source data to print and identify the target printer from a list of printers that may be selected to print the hard copy output;
receiving the source data from the originating device at the Web server;
passing the source data to a print server;
determining whether the source data comprises a printer file, and if it does,
submitting the source data to a print spooler; and
routing an output of the print spooler to the target printer.

60. A system to enable a user of an originating device to print source data on a target printer, comprising:
Web server means for serving one or more interactive Web pages to enable the user to select the source data to print and identify the target printer via a browser running on the originating device that renders the interactive Web page(s) and to receive a print request that includes the source data and identifies the target printer;
means for passing the source data from the Web server means to a print server computer;
means for determining whether the source data comprises a printer file, and if it does,
means for submitting the source data to a print spooler; and
means for routing an output of the print spooler to the target printer.
